(19) United States
(12) Patent Application Publication
(10) Pub. No.: US 2020/0262143 A1
(43) Pub. Date: Aug. 20, 2020

(54) AUTOMATIC TOOL CHANGER FOR AUGMENTED FUSED DEPOSITION MODELLING THREE DIMENSIONAL (3D) PRINTING

(71) Applicant: Christopher John Gibson, Cambridge (CA)

(72) Inventor: Christopher John Gibson, Cambridge (CA)

(21) Appl. No.: 16/278,058

(22) Filed: Feb. 16, 2019

(51) Int. Cl. B29C 64/209; B33Y 10/00; B33Y 30/00; B29C 64/118; B29C 64/227

(52) U.S. Cl. CPC B29C 64/209; B33Y 10/00; B29C 64/227; B29C 64/118; B33Y 30/00

(57) ABSTRACT

An automatic tool changing system and method for printing functional three-dimensional (3D) object is disclosed. The system is preferably comprised of an end-effector moveable about the X, Y and Z-axis, the end-effector connecting to various functional heads by means of a dovetail joint. Each functional head is responsible for a different type of functional printing as required by the 3D object, and each functional head is positioned on a docking station for ease of access by the end-effector. The method to print a functional 3D object is comprised of printing a first portion of the object, using the various functional heads to print functional components of the object, and then finishing printing the 3D object.

### FIELD

This disclosure relates to the field of additive manufacturing using robots to create three-dimensional (3D) objects from a computer model. More specifically, this disclosure relates to a deposition method of manufacturing to facilitate create a 3D object with augmented functionality.

### BACKGROUND

As computers within manufacturing have advanced, so have methods of producing 3D computer models and the ability to manufacture these models into objects using rapid prototyping techniques of which additive manufacturing is one of these techniques. These printed models often require post processing of features to obtain required precision and finish. These models are typically one or few colours and one or few materials and do not have any additional complexity such as embedded mechanical or electrical sub-systems

Therefore, there is a need to produce an augmented fused filament fabrication (FFF) printer that is capable of post processing including finishing and further colorization, and the ability to install internal electrical and or mechanical components or sub-assemblies and conductors that will be fully enclosed by the printed material. The present disclosure relates to these needs.

### SUMMARY

The current disclosure provides a system, apparatus and method for printing a full color complex functional 3D object that is internally electrically and mechanically assembled and the surfaces finished to a higher quality than currently capable by other 3D printing methods. A single or multi-colored multi-material filament extruder head is used along with other heads capable of various post processing functions; such system capable of automatically changing the functional heads as needed by robotic control. The system includes a three-dimensional robotic system that can translate an end-effector; the end-effector instrumented to automatically connect with any of the processing heads, one at a time; the heads are stored in a docking station using automatic connecting means. These other processing heads may include, but are not limited to, post colorization by means of an ink jet print head; a rotary machining tool; a measurement device such as a touch probe, a line scan or an area scan; a gripper capable of automatically inserting components or subassemblies into the 3D model; a wiring tool capable of laying insulated or non-insulated electrical conductor(s). The machine tooling head is optionally provided with two degrees of rotation for greater access, thus providing for drilling, boring, sanding, milling, or the like. The other functional heads may be invoked while the manufacturing of the 3D object is still in process. This allows access to internal structure or shrouded external structures that may not be accessible after the model is completed. Other aspects of the disclosure will become clear when reading the description of the preferred embodiments along with the accompanying figures.

### BRIEF DESCRIPTION OF THE DRAWINGS

The disclosure will now be described in detail, with reference to the accompanying drawings of preferred and exemplary embodiments, in which:

The disclosure will now be described in detail, with reference to the accompanying drawings of preferred and exemplary embodiments, in which:

FIG. 1 is front a diagram of the full system;

FIG. 2 is a top detailed view of an embodiment with a full colour extruder head and a colour ink jet head;

FIG. 3A is a perspective view of a single docking station pentahedronal dovetail joint;

FIG. 3B is a perspective view of a generic functional head with two perpendicular pentahedronal dovetail joints;

FIG. 3C is a perspective view of the robot end-effector with a pentahedronal dovetail joint;

FIG. 4 is a perspective view of a machining tool head;

FIG. 4B is a front view of a docking station of machine bits that can be automatically loaded into the machining tool head;

FIG. 5 is a perspective view of an assembly tool head;

FIG. 6 is a perspective view of a wiring tool head;

FIG. 7 is a perspective view of a touch probe measurement head;

FIG. 8 is a perspective view of a laser line scan measurement head;

FIG. 9 is a front view of an electronic connection means using spring driven pins;

FIG. 10 is a flowchart depicting the method to produce a complex functional 3D model;

FIG. 11 is a perspective view of mechanically actuated support pins;

FIG. 12 is a perspective view of a custom shaped support print bed;

FIG. 13 is a perspective view of fixed size support blocks;

FIG. 14 is a perspective view of an encapsulated component used for print support;

FIG. 15 is a front view of fixed height support blocks in a printed support platform; and,

FIG. 16 is a perspective view of a variable height support block.

### DESCRIPTION OF THE PREFERRED EMBODIMENTS

There are many methods known in the art related to robotic displaced fused filament fabrication of a 3D model under computer control. There are known methods to provide more than one print head and automatically exchange them. The current disclosure provides a system, apparatus and method for augmented printing a full color 3D object that is also mechanically and electrically functional upon completion. The system uses a multi-colored multi-material filament extruder head and other heads capable of various post processing functions; such system capable of automatically changing the functional heads as needed by robotic control. This system provides for augmented functionality in that the 3D model can be further refined: surface colorization, machined surface finishing; holes drilled and optionally tapped; sub-assemblies and components installed; electrical conductors routed and connected to sub-assemblies; and quality control dimensional measurements can be made; all while the 3D model is still being printed. The other functional heads may be invoked while the manufacturing of the 3D object is still in process, thus post-process steps can therefore be completed in-process, allowing the greatest accessibility to the internal portions of the 3D model or shrouded external structures that may not be accessible after the model is completed. The system includes a three-dimensional robotic system that can translate an end-effector; the end-effector instrumented to automatically mechanically connect with any of the processing heads, one at a time; the heads are stored in a docking station using automatic mechanical connecting means. These other processing heads may include, but are not limited to, post surface colorization by means of an ink jet print head; a rotary machining tool; a measurement device such as a touch probe, a line scan or an area scan; a gripper capable of automatically inserting components or sub-assemblies into the 3D model; a wiring tool capable of laying insulated or non-insulated electrical conductor(s). Various tooling heads may optionally benefit with one, two or three degrees of rotation for greater access. The machining head provides for drilling, taping, boring, sanding, milling, or the like.

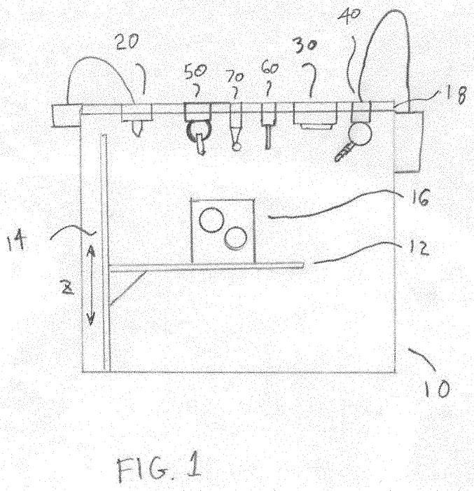

Turning to FIG. 1 a first embodiment of the full colour augmented complex 3D functional modeling system is shown. In this figure a front view of the apparatus 10 is shown. The functional model 16 is shown resting on the manufacturing platform 12. The platform 12 is adapted to move up and down in what is called the Z axis in this embodiment along the linear axis 14. Various functional heads are shown stored in the docking station 18. These heads are: a full colour multi-material fused filament extruder 20; a full colour ink jet print head 30; a machining spindle 40; an assembly placement tool 50, a wire placement tool 60 and a digitizing touch probe 70. In an alternate embodiment, extruder 20 is a single material single colour fused filament extruder. In other alternate embodiments the colour print head 30 is a single colour ink jet; is a colour mixing pneumatic paint head; and other painting methods.

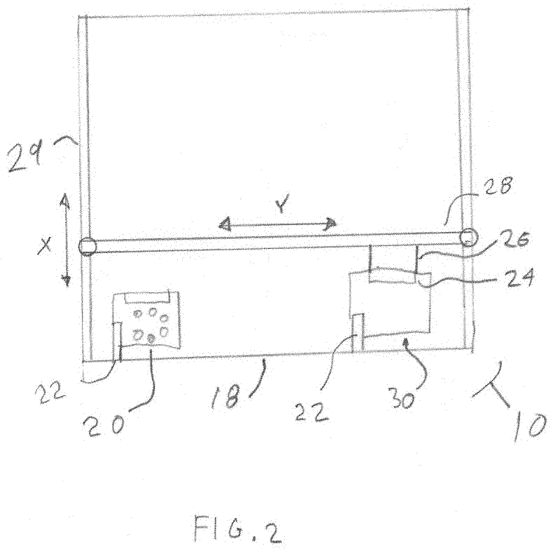

Now turning to FIG. 2 the top view of the apparatus 10 is shown. In this embodiment only two functional heads; the extruder 20 and the print head 30, are shown. An end-effector 26 is moved along the Y linear axis 28. The entire Y axis 28 complete with end-effector 26 is able to move along the X linear axis 29. The end-effector 26 has a single axis pentahedronal-shaped dovetail 24 connection means that is meant to be engaged in a single linear direction. In this shown embodiment, the single linear direction is denoted as the Y direction that is engaged in colour-ink-jet-print-head 30. The dovetail joint 24 is a connection means that has two mating pieces that slide together in one linear axis only and is further constrained to motion in one degree of freedom by the nature of the geometry. Two of the faces on each of the connecting portions are angled other than 90 degrees to constrain such motion. Mechanical force may be used to lock the two pieces into a repeatable and stable location while still allowing for loose tolerances. As shown, the print head 30 is still engaged with the docking station 18 single axis dovetail connection means 22. The print head 30 can be removed from the docking station 18 by performing a translation along the X-axis of the end-effector 26, removing print head 30 from connection means 22. Alternatively, the print head 30 can be removed from the end-effector 26 by performing a Y translation of the end-effector 26 removing it from connection 24. A worker skilled in the art would appreciate that the empty end-effector 26 can likewise be translated to the extruder head 20 and the operations repeated for this head 20.

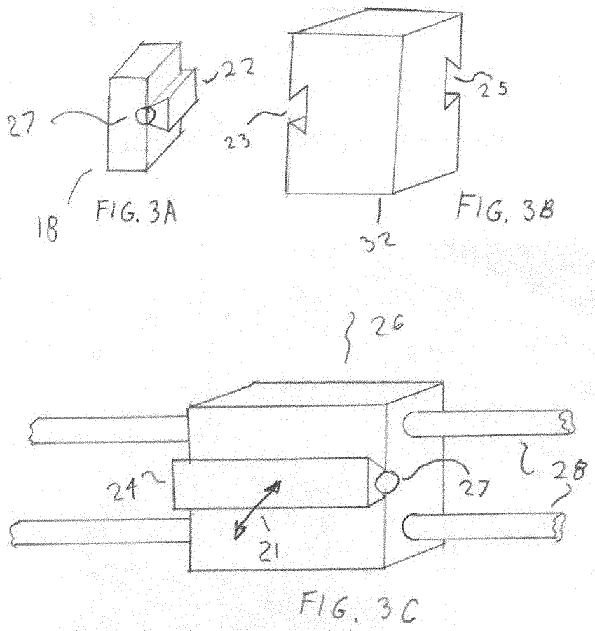

Turning to FIGS. 3A, 3B, and 3C the automatic connection of functional heads (generic head representation 32) can be made with the docking stations 18 and the end-effector 26. FIG. 3A represents a fragmented portion of the docking station 18. It should be clear that a single docking station is required for each functional head used in the system (not shown). This element of the docking station 18 has a pentahedronal dovetail structure 22, although a worker skilled in the art would appreciate that other shapes are possible. This geometry was chosen for ease of connecting and excellent repeatability. The connection can optionally be locked with a locking device 27. There are many methods to perform this locking such as, but not limited to, electric magnets, static magnets, passive spring locking, friction fittings, or electro-mechanical, hydraulic, pneumatic, servos, etc. Locking 27 may not be required at all. The dovetail structure 22 will engage with the generic head 32 dovetail socket 23 when the head 32 is in the docking station 18. Dovetail socket 25 will engage with the end-effector 26 when the head 32 is being activated for use in the creation of the 3D functional model. Note that sockets 23 and 25 are necessarily perpendicular to one another. With specific reference to FIG. 3C, an embodiment of the end-effector 26 is shown. It can be translated by various and well-known methods along the guide rails 28, such as with lead screws, belts or the like. The pentahedronal dovetail structure 24 is again optionally instrumented with a locking means 27 as described above. Either socket 25 or structure 24 can be further adapted to have compressive loading in the axis direction 21 such that positive pressure is applied to the faces of the dovetail and stable and repeatable positioning is obtained. This would allow for larger tolerances on the structure or socket.

It should be clear to those versed in the art that one head (shown in FIG. 1 as 20, 30, 40, 50, 60 or 70) at a time would be connected to the end-effector 26 and the remaining heads would be stored in their location in the docking station 18 during use. The heads would be translated in the X and Y axes while the 3D model can be translated up and down in the Z axis.

Some of the individual functional heads will now be disclosed. These heads are meant to be representative of many possibilities and not meant to limit the disclosure to these few samples. For example, a vacuum device may be used to remove material subtracted from the model (not shown). A head that performs sandblasting is possible, but not shown. A head that can provide air brush painting can be envisioned. A head that dispenses glue adhesives is similarly anticipated.

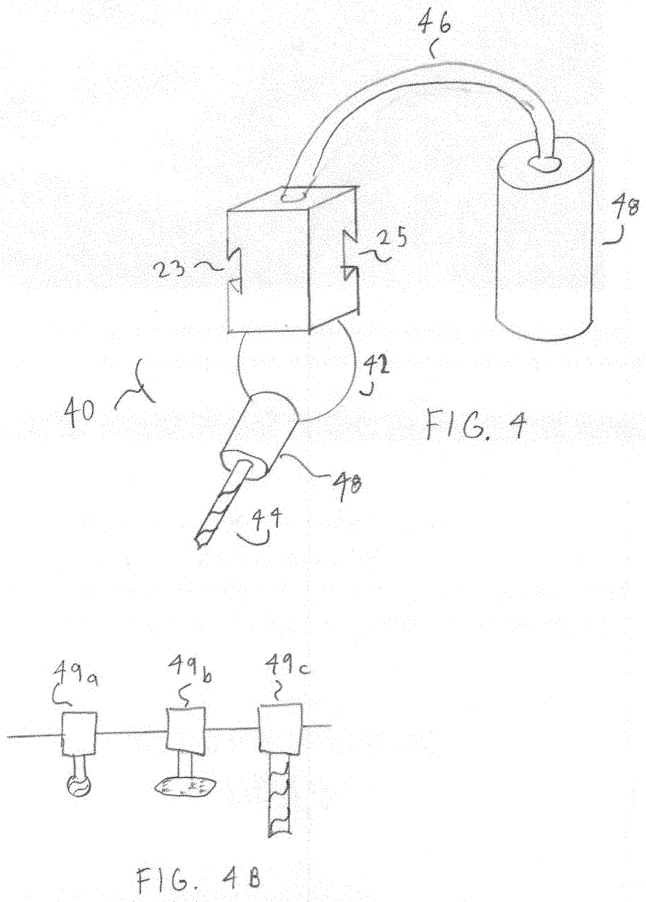

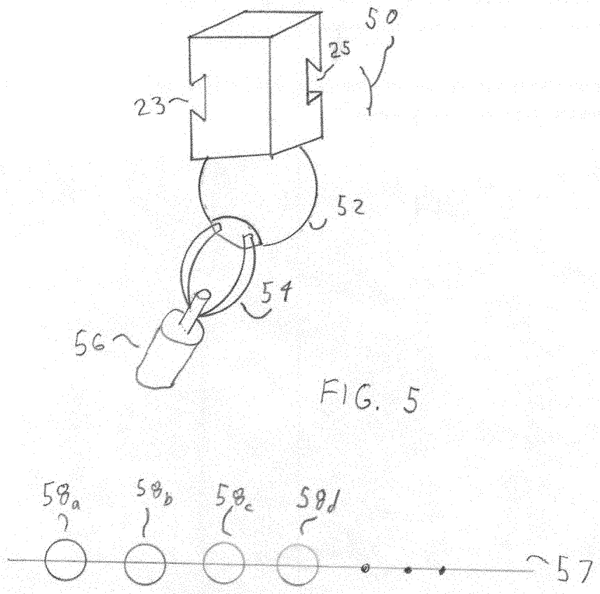

Referring to FIG. 4, a rotating machining head 40 is shown. In this embodiment power is transmitted to the spindle 48 by the flexible shaft 46 remotely connected to the spindle motor 48 that would be fixed to the frame of the apparatus (not shown). In this example, a drill bit 44 is installed in the spindle 48 for drilling operations. The computer controlled automated universal joint 42 is optionally used to give one or two more rotational degrees of freedom to orient the axis of the drill bit 44 and when combined with the three degrees of translation of the end-effector 26 (FIG. 3B) relative to the model 16 (FIG. 1) allows for drilling in any orientation. FIG. 4B shows a machine tooling docking station 49 that contains various machining tools that can be automatically placed in spindle 48, as is well known in the art. Tools such as drills, taps, reamers, sanding methods, grinders, mills of various shapes, boring bits, etc. may be utilized.

Referring to FIG. 5 a sub-assembly or component placement head 50 is shown. In this embodiment grippers 54 are attached to a computer controlled three rotation axis stage 52 that allows placing components 56 at any orientation. The grips can be rotated in this manner and the grips will open and close to pick components 56 and then to place them in the model. The mechanical grippers 54 could be replaced with other forms of holding an object, such as vacuum suction or electromagnetic for ferrous materials. Components 58a, 58b, etc. will be stored in tray 57 in installation order. In an alternative embodiment, the components are identified by automatic means, such as radio frequency tags or barcodes, and then selected appropriately. In yet another embodiment, components are further divided and stored in a plurality of trays that are within reach of the assembly head. Components such as batteries, motors, lights, sensors, circuit boards or others are anticipated.

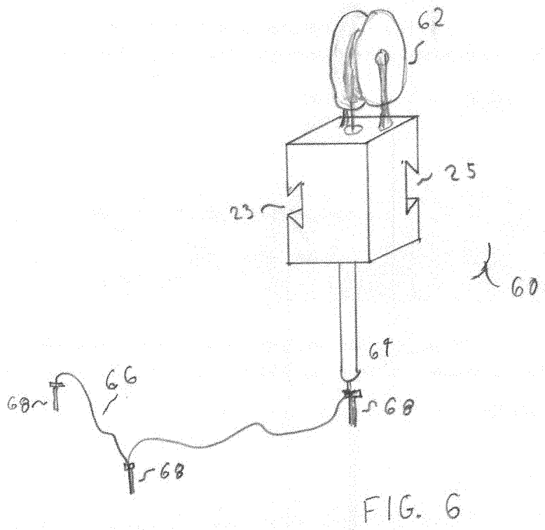

Turning to FIG. 6 a wiring head 60 is illustrated. In this example, conductive posts 68 were previously installed with head 50 (FIG. 5). A wire 62 from a spool is fed through the tip 64 by computer control. In this embodiment, the tip 64 is instrumented with a small arc welder that will weld a small portion of the wire 62 to the head of the metal posts 68. Other methods are anticipated such as insulation displacement connectors, soldering, or wire wrap methods. Insulated multi-conductor wires can be used as well as non-insulated single conductors.

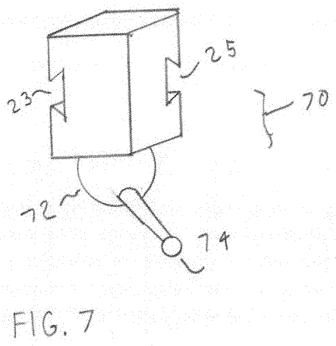

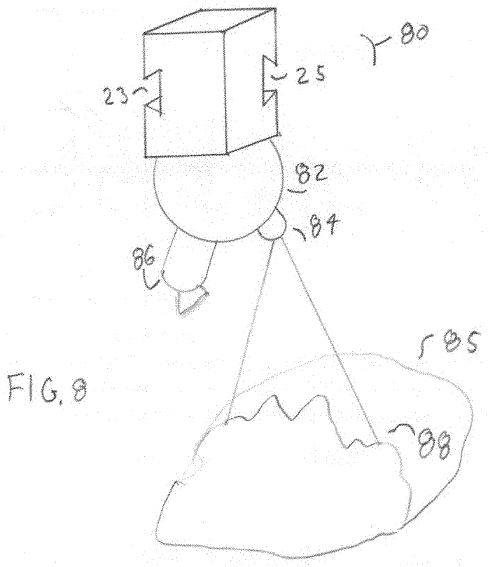

Measurement tasks are now shown with the use of measurement heads 70 and 80. Referring to FIG. 7 a touch probe 70 is presented. The imitation ruby sphere 74 is connected to a computer controlled two degree of rotation stage 72. When the sphere 74 contacts a surface the 3D location of the center of the sphere 74 is captured. This measured point can be used for a variety of purposes. One anticipated use is to determine the as-built geometry of the 3D model prior to installing functional components. This method will correct for inaccuracies in the 3D manufacturing of the model (not shown). A second example of a measurement head 80 is shown in FIG. 8. This head 80 has a line laser 84 projected onto the working area of the apparatus, along with a two-dimensional image sensor 86 located at a distance from laser 84. The line laser 84 creates a plane of light that will intersect with the surface of an object 85 and form a line of light 88 viewable by sensor 86. The 3D points along line 88 can be determined using triangulation methods as are well known in the art. The laser 84 and sensor 86 can be rotated by computer control with the three degree of rotation stage 82.

Referring to FIG. 9 the optional electrical connection method can be understood. In the preferred embodiment each functional head will be stored in a specific docking station 18. Although not shown, each head will require electrical and possibly mechanical connections and other forms of connections. For example, the extruder head 20 will require filament fed from a spool typically attached to the external structure of the printer. The machining head 40 has a flexible shaft 46 attached to the fixed motor 48. These attachments will be placed very close to the appropriate docking stations 18. As there is only one head active at a time, these attachments will not conflict or get tangled with each other. However, it may be convenient for the electrical signals to be optionally broken when the particular head is not in use. In FIG. 9 a diagram is shown of a type of spring loaded pins that will make positive contact when the head is invoked in the end-effector 26 (FIG. 2). In this manner, electrical conductors can be fed to the end-effector 26, along the axes of the robot and only make contact to the head when it is in use. Electrical conductors can be used to provide power, sensing and communication to the particular head. Electrical connection can also be made in a similar manner at the docking station 18. This could be used to maintain temperature of a heated component while that head is not in use. It should be clear to those versed in the art that power could also be provided by batteries in each or some of the functional heads and sensing and communication could be obtained using wireless communication.

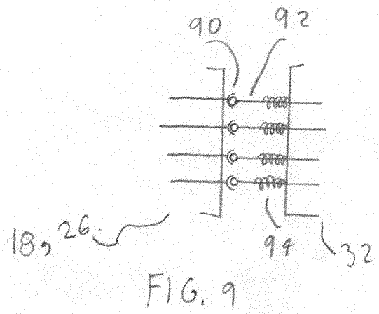

Turning to FIG. 10 the example steps are shown for a method to produce a complex functional 3D object. In this example a fully enclosed electronic printed circuit board is installed inside a 3D model and is connected with wires through an access cover. The external surfaces are machine finished and coloured. Holes are drilled and taped and a logo is applied. The method starts with step 100, printing about two inches of the base of the 3D object with extruder 20. At step 102 the printed circuit board is installed using assembly head 50. At step 104 the machining head 40 is used to sand and finish the exposed surfaces of the 3D object. Then paint head 30 is used to add the desired colour to these surfaces. At step 106 about two more inches of material is printed using extruder head 20, thus fully enclosing the printed circuit board except for access points to connectors. In step 108 the wiring head 60 is invoked to make connections to the printed circuit board through the access holes. At step 110, existing holes are in the 3D model are drilled to higher tolerances and threads are taped using machining head 40. The machining head 40 is then used to sand the exposed surfaces printed in step 106. In the final step 112 to print head 30 is used to print a logo onto the top of the 3D model.

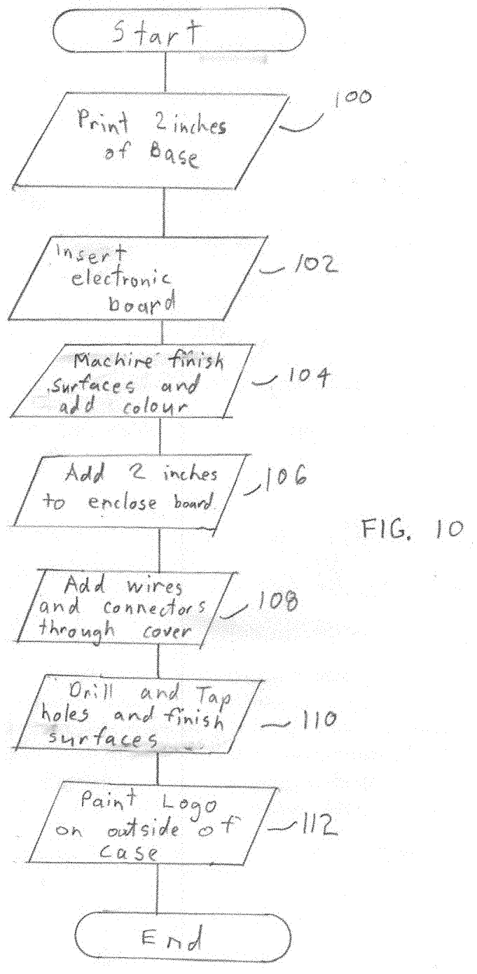

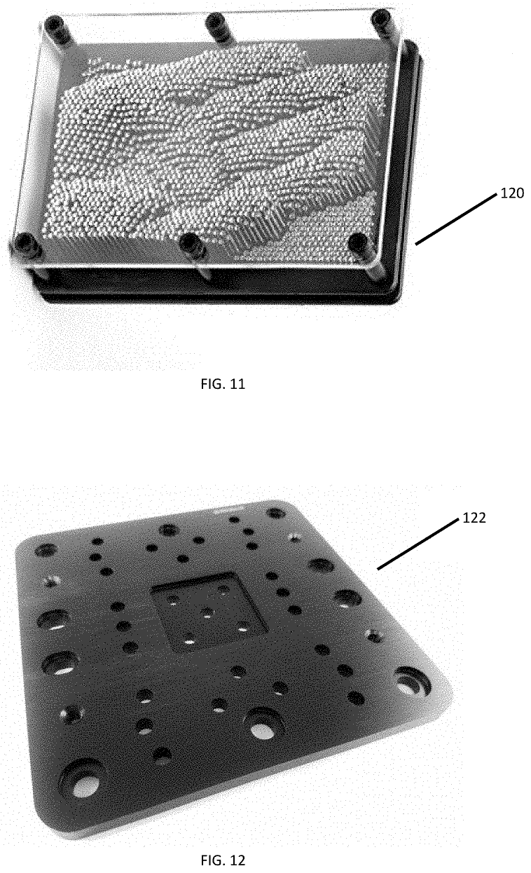

Support structures can be implemented with this augmented print system 10 thus eliminating or reducing the need to print support material. Several alternative embodiments are now presented in FIGS. 11, 12, 13, 14, 15, and 16.

Referring to FIG. 11 a collection of pins 120 can be used. The pins 120 can be set to the appropriate height either by mechanical activation below the print plate or can be extended from the print plate using the component placement head 50. These pins are used to support fused deposition printing of structures that bridge large spans or overhangs in the 3D model. The pins 120 can be have flat heads that are coated to improve adhesion of the printing material yet still be easy to separate from the final print. The pins may also be heated to the same temperature as the print bed. If pins 120 are raised by mechanical activation below the print plate, it is then possible to retract the same pin after completion of the print easing the separation from the final 3D model 16.

Turning now to FIG. 12 a fixed support plate 122 is shown. It can be placed at the beginning of the print by hand or by the component assembly head 50. This plate is built specifically for each unique desired model to be printed and would be practical when printing a plurality of the same model.

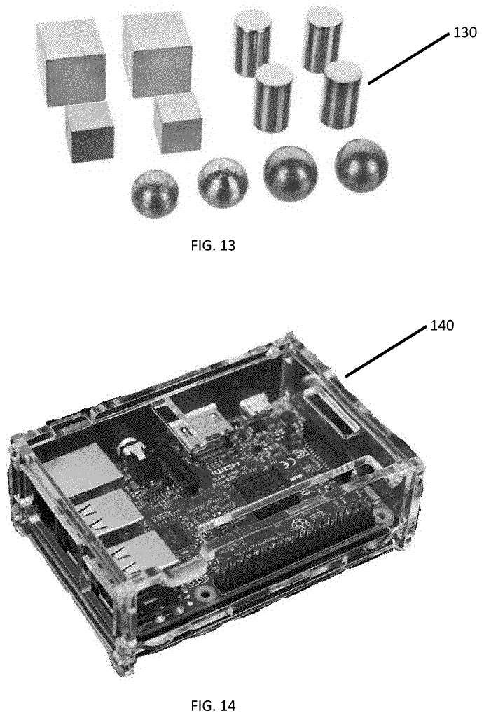

Referring to FIG. 13 a number of fixed size support blocks 130 are shown. These blocks 130 will be placed as needed during the print process manually by hand or by component placement head 50 and are used to support wide span bridges or overhangs in the 3D model.

Turning to FIG. 14 an electrical assembly 140 is shown that is encapsulated with material. This material can be selected for direct printing adhesion and in this case the assembly 140 is providing support for further printing the 3D model 16.

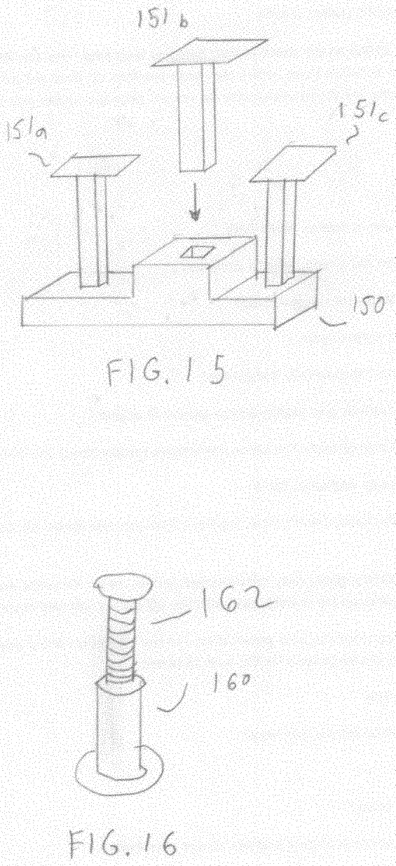

Turning to FIG. 15 a method is illustrated in which fixed height support blocks 151a, 151b, 151c are inserted into a printed support section 150 that is printed at the same time as the model but is not part of the model. Sockets 152 can be printed into the support section 150 and the depth of the socket 152 can be designed such that the final height of the support blocks 151 is at the appropriate height to support overhangs and wide bridge spans of the 3D model.

Turning to FIG. 16 a single embodiment of an adjustable height support post is shown. It consists of a base 160 and a top 162. The base 160 and the top 162 are threaded such that the top 162 will go into and out of the base 160 as the top 162 is rotated clockwise or counter-clockwise. This rotation can be done by hand or automatically by the component placement head 50. These blocks will then be placed as needed throughout the print process by component placement head 50 to support wide span bridges or overhangs in the 3D model.

In the preceding description, for purposes of explanation, numerous details are set forth in order to provide a thorough understanding of the embodiments; however, the specific details are not necessarily required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

The above-described embodiments are intended to be examples only. Alterations, modifications and variations can be effected to the particular embodiments by those of skill in the art without departing from the scope, which is defined solely by the claims appended hereto.

1. An automatic tool changer system for printing a functional three-dimensional object comprising:
an end effector constructed and arranged to connect to a plurality of functional heads;
a plurality of docking stations, each docking station further comprised of a connector to connect to the plurality of functional heads;
at least one functional head releasably secured to the end effector to print the functional 3D object.

2. A method to create a functional three-dimensional object, the steps comprising:
printing a first portion of the 3D object;
using an end-effector to releasably secure to a first functional head;
using the first functional head to print functional characteristics of the 3D object; and,
printing a second final portion of the 3D object.

3. Any invention as may be defined in the above description.

4. An apparatus with a 3D translation robot; an end effector translated by the robot and instrumented with connection means adapted to dock with a functional head; a plurality of docking stations with connection means; one functional head being the fused deposition extruder head and at least one other head of a different function, these heads instrumented with compatible connection means allowing automatically changing the heads with the end-effector and with the docking station(s).

5. The apparatus of claim 1 but the connection means for the docking station and the end-effector are pentahedronal shaped dovetails structures and sockets.

6. The apparatus of claim 2 with the connection axis on the end-effector is perpendicular to the connection axis on the docking station; and the changeable heads have two compatible perpendicular connection means.

7. The apparatus of claim 1 with a functional head being a colour inkjet printing head.

8. The apparatus of claim 1 with a functional head being a component insertion device.

9. The apparatus of claim 1 with a functional head being a rotary tool for drilling, machining or the like.

10. The apparatus of claim 6 where the rotary tool has one or two additional robotic rotation stages.

11. The apparatus of claim 1 with a functional head being a probe for taking a 3D point measurement.

12. The apparatus of claim 1 with functional head being a line or surface scanner taking point cloud surface measurements.

13. The apparatus of claim 1 with the functional head being adapted to insert electrical conductor(s) into the 3D model.

14. The apparatus of claim 1 with spring loaded electrical connection pins on the end-effector designed to mate with the functional head, providing power, sensing, communication and identification.

15. The apparatus of claim 11 with spring loaded electrical connection pins also on the docking station that can mate with the functional head providing power, sensing, communication and identification while the functional head is not actively in use.

16. The apparatus of claim 1 with a functional head instrumented to install bare or insulated electrical conductor(s).

17. The apparatus of claim 5 with the component insertion device adapted to place supporting blocks or pins to support large spans or overhangs in the 3D model.

18. The apparatus of claim 14 where the pins are articulated to the appropriate height by the component insertion head.

19. The apparatus of claim 14 where the pins are articulated by mechanical means below the print bed.

20. The apparatus of claim 14 where the support blocks are adapted to have adjustable height that is configured by manipulation from the component insertion device.
